(19) United States
(12) Patent Application Publication
(10) Pub. No.: US 2015/0350303 A1
(43) Pub. Date: Dec. 3, 2015

(54) MANUFACTURING OPTIMIZATION PLATFORM AND METHOD

(71) Applicant: CHIA-I LIN, TAIPEI CITY 105 (TW)

(72) Inventor: CHIA-I LIN, TAIPEI CITY 105 (TW)

(21) Appl. No.: 14/289,844

(22) Filed: May 29, 2014

(51) Int. Cl. H04L 29/08; H04L 29/06; H04L 12/24

(52) U.S. Cl. CPC H04L 67/10; H04L 67/12; H04L 41/22; H04L 67/42

(57) ABSTRACT

A platform and method for optimizing manufacturing comprising a service box, an application server, an agent server, and a cloud server. The service box is coupled to sensors on a production machine. The service box receives appropriate data from the sensors and transfers the data to the cloud server in real-time. The agent server comprises a plurality of analysis tools and management tools that have been developed by and downloaded from the application server. The analysis tools and management tools comprise applications that analyze sensor data and produce effective results to manage production efficiency and maximize overall equipment effectiveness. The cloud server utilizes the analysis tools and management tools available on the agent server or available directly on the cloud server with the sensor data received in real-time from the service box to obtain results. The analysis results are provided to a client device by the cloud server.

### BACKGROUND OF THE INVENTION

1. Field of the Invention

The present invention relates to production systems. More specifically, the present invention discloses a platform and method for optimizing manufacturing by utilizing a service box to provide data obtained from sensors on production machines to a cloud server an applying analysis tools provided by an agent server.

2. Description of the Prior Art

Manufacturing factories use various machines to produce products. The performance of the machines directly affects the cost of production and the profit available when selling the products.

In order to improve machine performance traditional factories employ numerous technicians to maintain the machines.

Conventional production systems also use employees to regularly take readings from the machines, input production data, and create reports. The reports are then analyzed by management.

This manual method is not only ineffective but the data can be input incorrectly and due to unclear data the reports can be neglected thereby failing to improve production efficiency.

Therefore, there is need for an efficient method for optimizing manufacturing by using a platform to obtain data from production machines and utilizing intelligent analysis tools on the data.

### SUMMARY OF THE INVENTION

To achieve these and other advantages and in order to overcome the disadvantages of the conventional method in accordance with the purpose of the invention as embodied and broadly described herein, the present invention provides a platform and method for optimizing manufacturing by utilizing a service box to provide data obtained from sensors on production machines to a cloud server and using analysis tools provided by an agent server to improve production efficiency.

The platform and method for optimizing manufacturing of the present invention comprises a service box, an application server, an agent server, and a cloud server.

The service box comprises a hardware box with electronic circuits, firmware, and software. The service box is coupled to sensors on a production machine.

The service box requests and receives appropriate and accurate data from the sensors and transfers the data to the cloud server in real-time.

The application server comprises a plurality of analysis tools and management applications that are in development or have been completed by application designers and programmers and published on the application server.

The agent server comprises a plurality of analysis tools and management tools that have been downloaded from the application server and available for direct use on the agent server or for download to the cloud server. The analysis tools and management tools comprise applications that analyze sensor data and produce effective results to manage production efficiency and maximize overall equipment effectiveness. The analysis and management tools comprise, for example, tools for troubleshooting, production scheduling, quality control, health diagnosis, utilization magnifier, and energy monitoring.

The cloud server comprises a plurality of analysis tools and management tools that have been provided by the agent server. The cloud server utilizes the analysis tools and management tools available on the agent server or available directly on the cloud server with the sensor data received in real-time from the service box.

The platform and method for optimizing manufacturing of the present invention further comprises a client device. The client device comprises a service dashboard for displaying an efficient visualization of the various results of the analysis tools and management tools provided by the cloud server. The user of the client device effectively monitors and administrates various aspects of production via the service dashboard and communicating with the cloud server.

As a result, the present invention effectively and efficiently monitors, analyzes, and manages production processes to optimize manufacturing by increasing machinery and production efficiency to lower costs and increase profits.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is drawing illustrating a manufacturing optimization platform and method according to an embodiment of the present invention;

FIG. 2 is a flowchart illustrating a manufacturing optimization platform and method according to an embodiment of the present invention;

FIG. 3 a drawing illustrating multiple cloud servers of a manufacturing optimization platform and method according to an embodiment of the present invention;

FIG. 4 is a drawing illustrating multiple service boxes of a manufacturing optimization platform and method according to an embodiment of the present invention;

FIG. 5A is a drawing illustrating a service dashboard on a client device according to an embodiment of the present invention; and

FIG. 5B is a drawing illustrating a service dashboard on a client device according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

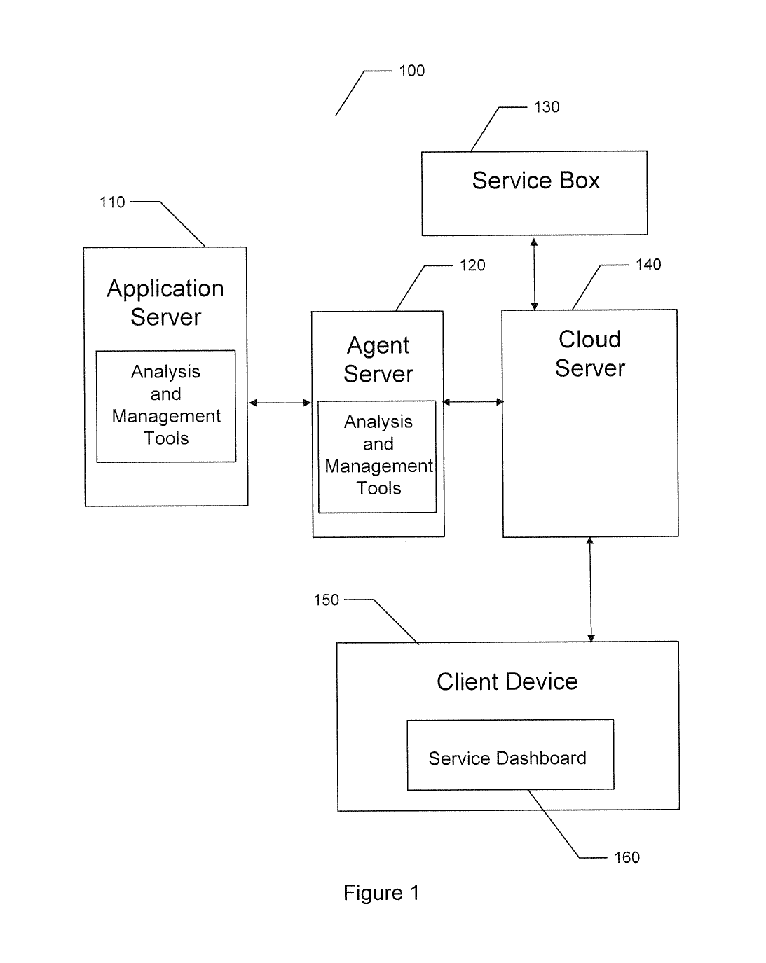

Refer to FIG. 1.

The manufacturing optimization platform and method 100 comprises an application server 110, an agent server 120, a service box 130, a cloud server 140, and a client device 150.

The application server 110 connects with the agent server 120. The agent server 120 connects with the application server 110 and the cloud server 140. The service box 130 connects with the cloud server 140 and sensors of a production machine. The client device 150 connects with the cloud server 140. The cloud server connects with the agent server 120, the service box 130, and the client device 150.

The connections between the application server 110, the application server 120, the service box 130, the cloud server 14, and the client device 150 comprise a wireless network, a wired network, or a combination of wireless networks and wired networks.

The application server 110, the application server 120, the cloud server 14, and the client device 150 comprise servers, computers, tablets, smart phones, or other electronic devices capable of connecting to the platform 100.

The application server 110 comprises analysis and management tool applications that are still in development or have been completed and are available for distribution. Developers utilize the application server 110 while creating and programming the analysis and management tools. When the analysis and management tools are ready for distribution, the analysis and management tools are published on the application server 110 and the agent server 120 is notified.

The agent server 120 connects with the application server 110 to access and download the published analysis and management tools.

The analysis and management tools comprise, for example, tools for data acquisition, health indicator extraction and selection, health assessment, visualization, performance prediction, quality analysis, projection, inventory, equipment effectiveness, monitoring and production, troubleshooting, production scheduling, quality control, health diagnosis, utilization magnifier, energy monitoring, knowledge management, data analysis, system management, customer management, remote monitoring, technical documents, service management, scheduling, and employee management.

Customized tools are available that have been requested by the cloud server 140 from the agent server 120 and developed by the application server 110 to meet specific needs required by the users of the cloud server 140.

The service box 130 comprises a hardware box with electronic circuits, firmware, software, and input/output connections. The service box 130 is coupled to sensors on a production machine. The service box 130 requests and receives appropriate and accurate data from the sensors and transfers the data to the cloud server 140 in real-time.

The sensors comprise such sensors as, for example, programmable logic controllers (PLC), computer numerical control (CNC) controllers, pressure sensors, power sensors, vibration sensors, temperature sensors, acoustic sensors, global positioning system (GPS) sensors, and enterprise resource planning (ERP)/manufacturing execution systems (MES) information technology (IT) systems.

The server box 130 is configurable to connect with the desired sensor(s) and receive the desired sensor data.

The cloud server 140 receives the sensor data from the service box 130 in real-time. The cloud server 140 is also capable of reconfiguring which sensors the service box 130 is connected to. The cloud server 140 comprises a plurality of analysis tools and management tools that have been provided by the agent server 120. The cloud server 140 utilizes the analysis tools and management tools available on the agent server 120 or available directly on the cloud server 140 with the sensor data received in real-time from the service box 130. In an embodiment of the present invention the analysis and management tools are locally stored and executed on the cloud server 140. In another embodiment the analysis and management tools are stored and executed on the agent server 120.

The platform and method for optimizing manufacturing 100 of the present invention further comprises a client device 150. The client device 150 comprises a service dashboard 160 for displaying an efficient visualization of the various results of the analysis tools and management tools provided by the cloud server 140. The user of the client device 150 effectively monitors and administrates various aspects of production via the service dashboard 160 and communicating with the cloud server 140.

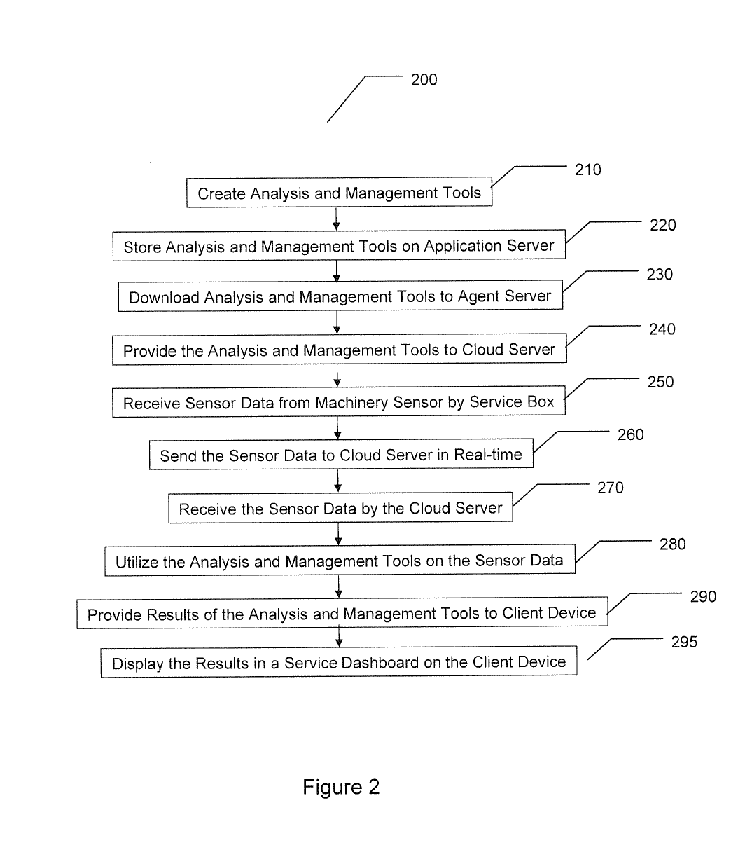

Refer to FIG. 2.

The manufacturing optimization platform and method 200 comprises creating analysis and management tools in Step 210. In Step 210 application developers utilize the application server to create and develop the analysis and management tools that are used within the platform. In Step 220, the analysis and management tools in development or are finished are stored on the application server. When the tools are complete, the tools are published on the application server and the agent server is notified that the analysis and management tool is ready for distribution. During development and when published the analysis and management tools are stored on the application server.

In Step 230, after the agent server has been notified that the application and management tools have been published, the application and management tools are downloaded from the application server to the agent server. The cloud server is notified of the new or updated versions of the analysis and management tools.

In Step 240, the analysis and management tools on the agent server are provided to the cloud server. In an embodiment of the present invention the analysis and management tools ore downloaded to the cloud server automatically. In another embodiment of the present invention the analysis and management tools are downloaded as needed or desired by the cloud server.

In Step 250, the service box coupled to the machinery sensor or sensors receives appropriate sensor data from the sensor(s). This sensor data comprises, for example, temperature, viscosity, noise level, vibration, material quantity or volume, product count, etc. In Step 260, the service box transmits the sensor data to the cloud server in real-time. In Step 270, the transmitted sensor data is received by the cloud server.

In Step 280, the cloud server utilizes the analysis and management tools on the sensor data. For example, when the sensor data comprises the current temperature of the mold on the machine, the analysis and management tool tracks the temperature and produces a record or history of the temperature, produces an alarm if the temperature is too high or too low, and other useful analysis.

In Step 290, the results from the analysis and management tools on the sensor data are provided to the client device by the cloud server. In an embodiment of the present invention the results are transmitted to the client device automatically. In another embodiment the results are provided upon a request from the client device.

In Step 295, the results are displayed in the service dashboard on the client device.

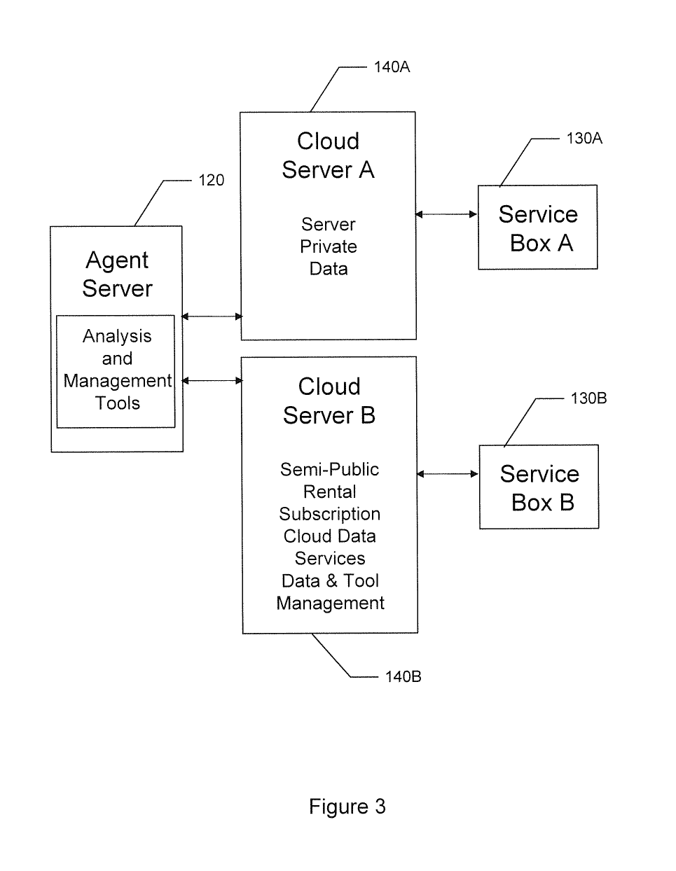

Refer to FIG. 3.

The present invention provides flexibility for the client by offering various configurations for the cloud server and the platform service. In the embodiment illustrated in FIG. 3, a plurality of cloud servers connect to the agent server 120. Cloud server A 140A connects with service box A 130A and cloud server B connects with service box B 130B and both cloud servers 140A 140B connect to the same server agent 120.

Cloud server A 140A is configured as a private cloud server. A private cloud server comprises private data that is only accessible to the client. Cloud server A 140A connects to the agent server to download analysis and management tools. All data, for example, sensor data, production data, analysis data, and management data are kept on cloud server A 140A and not publicly available. A private cloud server such as cloud server A 140A provides a high level of security for sensitive manufacturing data for the client.

Cloud server B 140B is configured as a semi-public cloud server where some or all of the data on cloud server B 140B is available to the service agent 120. Service agent 120 provides cloud data services as well as analysis and management tool management services for cloud server B 140B. For example, the service agent 120 routinely updates the analysis and management tools, provides access to new tools, performs analysis on production data, and maintains cloud server B 140B. A semi-public cloud server such as cloud server B 140B is more economical to maintain to smaller companies or clients without a dedicated technical support team.

In an embodiment of the present invention the analysis and management tools are subscription based. The client can choose which analysis and management tools they need and pay for use of the tools rather than purchasing the tools. This allows the client to avoid paying for tools they may not need. This further lowers the cost of establishing the platform of the present invention.

In an embodiment of the present invention the analysis and management tools are purchased individually with a varying cost depending on complexity of the tool.

In an embodiment of the present invention the analysis and management tools are rented. This allows the client to return the tool when they have finished using or no longer need the tool. For example, if the tool is an inventory efficiency tool that analyzes the efficiency annually, the client can rent the tool once a year for a short period and then return the tool.

In an embodiment of the present invention the service box is rented to the client. This provides flexibility in increasing or decreasing the number of service boxes as machines are added or removed from the production facility. By renting the service boxes, cost of the platform of the present invention can be easily controlled by the client and initial cost is lowered compared with purchasing the service boxes initially.

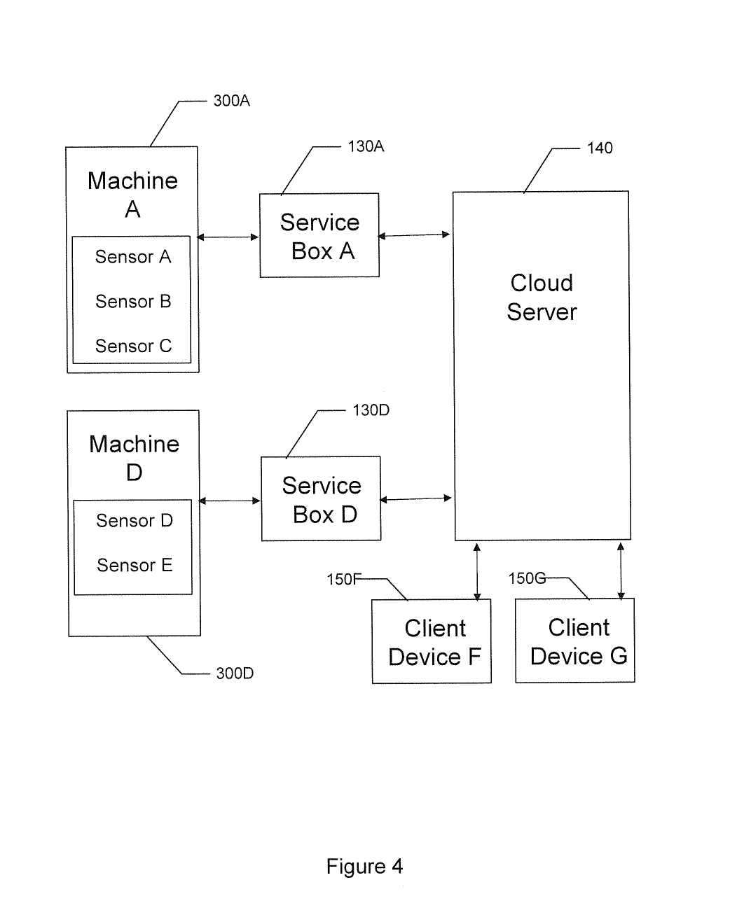

Refer to FIG. 4. In the embodiment illustrated in FIG. 4 a plurality of service boxes connect to the same cloud server. Service box A 130A connects with machine A 300A and receives sensor data from sensor A, sensor B, and sensor C of machine A 300A. Service box A 130A transmits the received sensor data to the cloud server 140. Service box D 130D connects with machine D 300D and receives sensor data from sensor D and sensor E of machine D 300D. Service box D 130A transmits the received sensor data to the cloud server 140.

The cloud server 140 connects with a plurality of client devices (client device F 150F and client device G 150G). Data such as, for example, sensor data, analysis data, management data, and machine data from both machine A 300A and machine D 300D is made available to both client device F 150F and client device G 150G or either depending on access privileges.

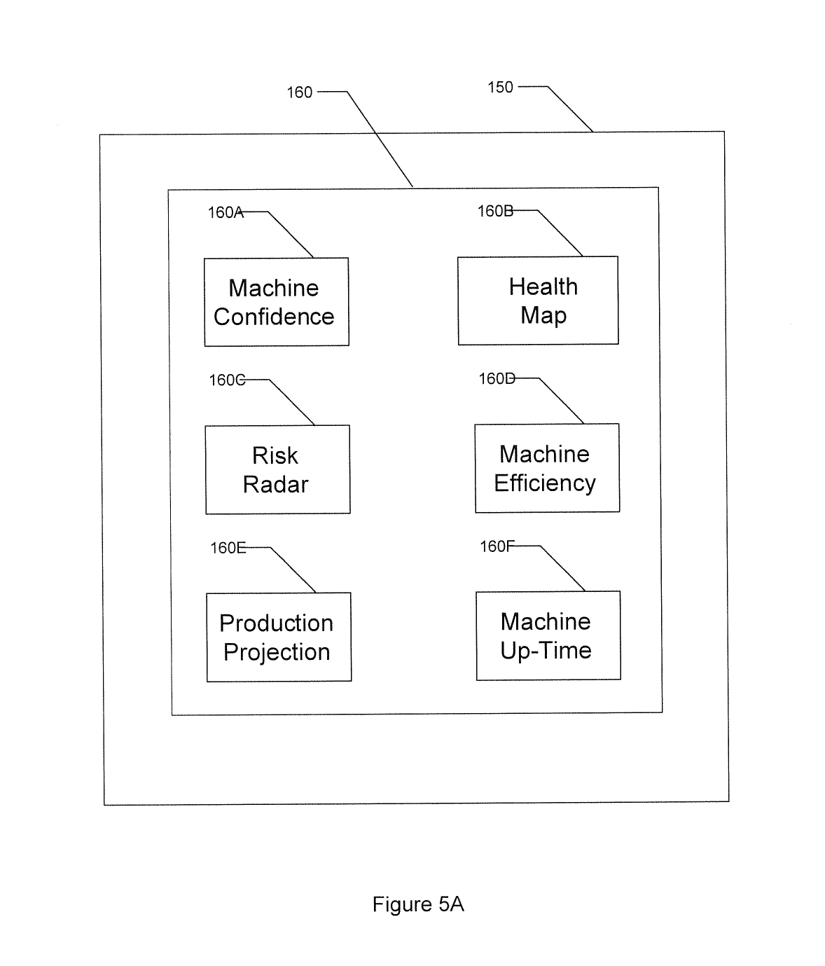

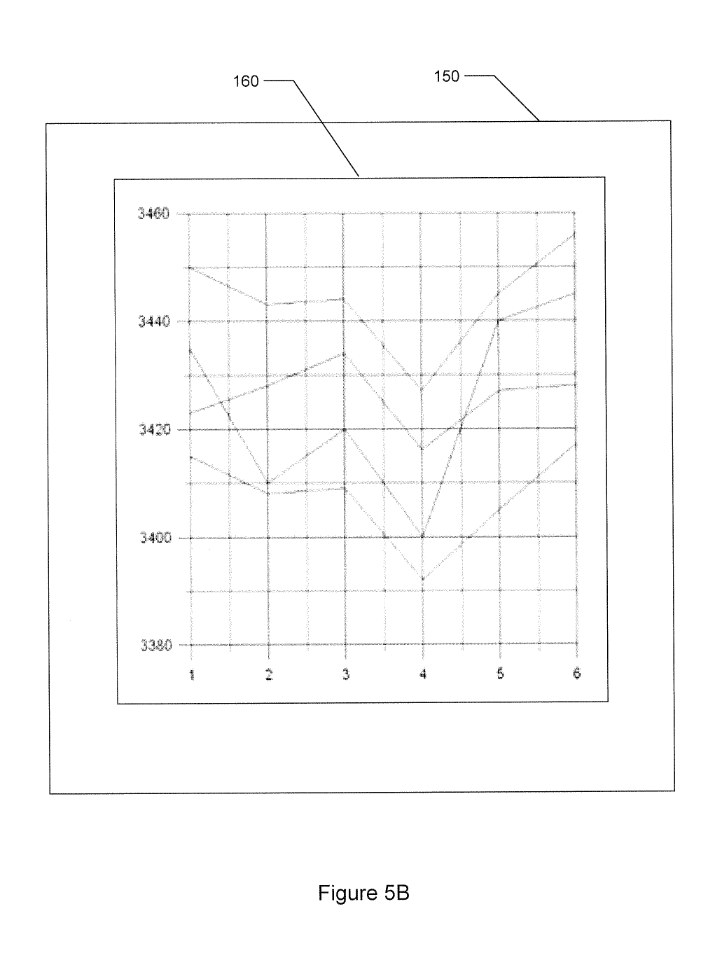

Refer to FIGS. 5A and 5B. The service dashboard 160 on the client device 150 provides a means for a user to access analysis results and data provided by the cloud server. The service dashboard 160 comprises, for example, a display of available tools, reports, graphs, charts, maps, histories, logs, schedules, quantities, inventories, documents, orders, or projections.

In the embodiment illustrated in FIGS. 5A and 5B the service dashboard 160 displays icons 160A-160F of available tools and data accessible to the user of the client device 150. Clicking on one of the icons brings up a visualization of the selected icon. For example, if the user selects an icon for production quantity the service dashboard 160 displays a graph of the current production volume as well as showing the past volume history. In this way, the user can easily see valuable information in real-time rather than reading through a printed report.

In an embodiment the service dashboard 160 is configurable for individual users and only displays appropriate tools and data for each user. For example, quality assurance personnel do not see financial, ordering, or shipping information. This prevents information overload and confusion by simplifying the use of the platform.

In an embodiment the service dashboard 160 is configured to display appropriate data in real-time on the client device 150. For example, a worker on the on the production floor will see a real-time graph of machine performance on their client device 150 and not be confused by unnecessary data.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A platform and method for optimizing manufacturing comprising:
an application server, the application server for developing and publishing an analysis tool;
an agent server, the agent server for downloading and storing the analysis tool from the application server;
a service box, the service box receiving sensor data from a machinery sensor; and
a cloud server, the cloud server receiving sensor data from the service box, for accessing the analysis tool, for using the analysis tool on the sensor data to obtain analysis results, and for providing the analysis results to a client device.

2. The platform and method for optimizing manufacturing of claim 1, further comprising:
the client device comprising a service dashboard for displaying analysis results provided by the cloud server.

3. The platform and method for optimizing manufacturing of claim 1, wherein the cloud server is a private cloud server accessible to only a client.

4. The platform and method for optimizing manufacturing of claim 1, wherein the cloud server is a semi-public cloud server accessible by the agent server.

5. The platform and method for optimizing manufacturing of claim 2, wherein the service dashboard comprises a display of available tools, reports, graphs, charts, maps, histories, logs, schedules, quantities, inventories, documents, orders, or projections.

6. The platform and method for optimizing manufacturing of claim 1, wherein the sensor data comprises data from programmable logic controllers, computer numerical control controllers, pressure sensors, power sensors, vibration sensors, temperature sensors, acoustic sensors, global positioning system sensors, enterprise resource planning systems, or manufacturing execution systems.

7. The platform and method for optimizing manufacturing of claim 1, wherein the analysis tool comprises a tool for data acquisition, health indicator extraction and selection, health assessment, visualization, performance prediction, quality analysis, projection, inventory, equipment effectiveness, monitoring and production, troubleshooting, production scheduling, quality control, health diagnosis, utilization magnifier, energy monitoring, knowledge management, data analysis, system management, customer management, remote monitoring, technical documents, service management, scheduling, or employee management.

8. The platform and method for optimizing manufacturing of claim 1, wherein the analysis tool is downloaded from the server agent and accessed on the cloud server.

9. The platform and method for optimizing manufacturing of claim 1, wherein the analysis tool is accessed on the agent server.

10. The platform and method for optimizing manufacturing of claim 1, wherein the service box is rented from the service agent.

11. The platform and method for optimizing manufacturing of claim 1, wherein the analysis tool is subscription based from the service agent.

12. A platform and method for optimizing manufacturing comprising:
creating an analysis tool;
storing the analysis tool on an application server;
transferring the analysis tool from the application server to an agent server;
providing the analysis tool on the agent server to a cloud server;
receiving sensor data from a machinery sensor by a service box;
sending the sensor data to the cloud server in real-time by the service box;
receiving the sensor data by the cloud server;
utilizing the analysis tool on the sensor data;
providing results of the analysis tool to a client device by the cloud server; and
displaying the results in a service dashboard on the client device.

13. The platform and method for optimizing manufacturing of claim 12, wherein the analysis tool is downloaded from the agent server and accessed on the cloud server.

14. The platform and method for optimizing manufacturing of claim 12, wherein the analysis tool is accessed on the agent server.

15. The platform and method for optimizing manufacturing of claim 12, wherein the cloud server is a semi-public cloud server accessible by the agent server.

16. The platform and method for optimizing manufacturing of claim 12, wherein the service dashboard comprises a display of available tools, reports, graphs, charts, maps, histories, logs, schedules, quantities, inventories, documents, orders, or projections.

17. The platform and method for optimizing manufacturing of claim 12, wherein the sensor data comprises data from programmable logic controllers, computer numerical control controllers, pressure sensors, power sensors, vibration sensors, temperature sensors, acoustic sensors, global positioning system sensors, enterprise resource planning systems, or manufacturing execution systems.

18. The platform and method for optimizing manufacturing of claim 12 wherein the analysis tool comprises a tool for data acquisition, health indicator extraction and selection, health assessment, visualization, performance prediction, quality analysis, projection, inventory, equipment effectiveness, monitoring and production, troubleshooting, production scheduling, quality control, health diagnosis, utilization magnifier, energy monitoring, knowledge management, data analysis, system management, customer management, remote monitoring, technical documents, service management, scheduling, or employee management.

19. The platform and method for optimizing manufacturing of claim 12, wherein the service box is rented from the service agent.

20. The platform and method for optimizing manufacturing of claim 12, wherein the analysis tool is subscription based from the service agent.
